(19) United States
(12) Patent Application Publication
(10) Pub. No.: US 2016/0165808 A1
(43) Pub. Date: Jun. 16, 2016

(54) Method and Apparatus for Growing Plants

(71) Applicants: Nicholas G. BRUSATORE, Port Coquitlam (CA); Richard James Joseph DUCHARME, Surrey (CA)

(72) Inventors: Nicholas G. BRUSATORE, Port Coquitlam (CA); Richard James Joseph DUCHARME, Surrey (CA)

(21) Appl. No.: 14/966,854

(22) Filed: Dec. 11, 2015

Related U.S. Application Data
(60) Provisional application No. 62/090,636, filed on Dec. 11, 2014.

(51) Int. Cl. A01G 9/12; A01G 7/04; A01G 1/00

(52) U.S. Cl. CPC A01G 9/12; A01G 1/001; A01G 7/045

(57) ABSTRACT

System for growing plants especially strawberry and like plants that require cross-pollination to produce fruit and includes: providing a vertical stack of spaced, symmetrical growing stations each having a plant tray; placing plants to be grown on the plant trays; rotating the stack about its vertical axis while causing the plants to be contacted by a pollinator which cross-pollinates the plants; exposing the plants to growth promoting light sources during periods of plant growth; watering the plants at selected intervals; and cropping the plants when mature, for example, by picking mature strawberries.

### CROSS-REFERENCE TO RELATED APPLICATIONS

The present application claims priority on prior U.S. Provisional Patent Application Ser. No. 62/090,636, filed Dec. 11, 2014, which is hereby incorporated herein in its entirety by reference.

### FIELD OF THE INVENTION

The invention relates to a method and apparatus for growing plants, especially strawberry and like plants that require cross-pollination to produce fruit.

### SUMMARY OF THE INVENTION

The invention provides a method for growing plants especially strawberry and like plants that require cross-pollination to produce fruit and includes the following steps:
(a) providing a vertical stack of spaced, symmetrical growing stations each having a plant tray;
(b) placing plants to be grown on the plant trays;
(c) rotating the stack about its vertical axis while causing the plants to be contacted by a pollinator which cross-pollinates the plants;
(d) exposing the plants to growth promoting light sources during periods of plant growth;
(e) watering the plants at selected intervals; and
(f) cropping the plants when mature, for example, by picking mature strawberries.

The invention also provides apparatus for growing plants especially strawberry and like plants that require cross-pollination to produce fruit and includes the following:
(a) a vertical stack of spaced apart symmetrical growing stations each supporting a plant tray adapted to receive plants to be grown;
(b) means to rotate the stack about its vertical axis;
(c) means to cross-pollinate said plants as they rotate on their respective trays;
(d) growth promoting light sources positioned above each growing station adapted to operate during periods of plant growth; and
(e) means to deliver water to said plants at selected intervals.

### BRIEF DESCRIPTION OF THE DRAWINGS

One of the above and other aspects, novel features and advantages of the present invention will become apparent from the following detailed description of a preferred embodiment(s) of the invention, as illustrated in the drawings, in which:

FIG. 1 is a perspective view of apparatus suitable for carrying out the inventive method.

FIG. 2 is a bottom view of a growing station shown in FIG. 1.

FIG. 3 is a partial perspective view showing details of the growing stations shown in FIG. 1.

FIG. 4 is a side view showing several growing stations in the vertical stack shown in FIG. 1.

FIG. 5 is an expanded partial perspective view of the watering system used to deliver water and nutrients to the plants being grown.

### DETAILED DESCRIPTION OF THE PREFERRED EMBODIMENT(S) OF THE INVENTION

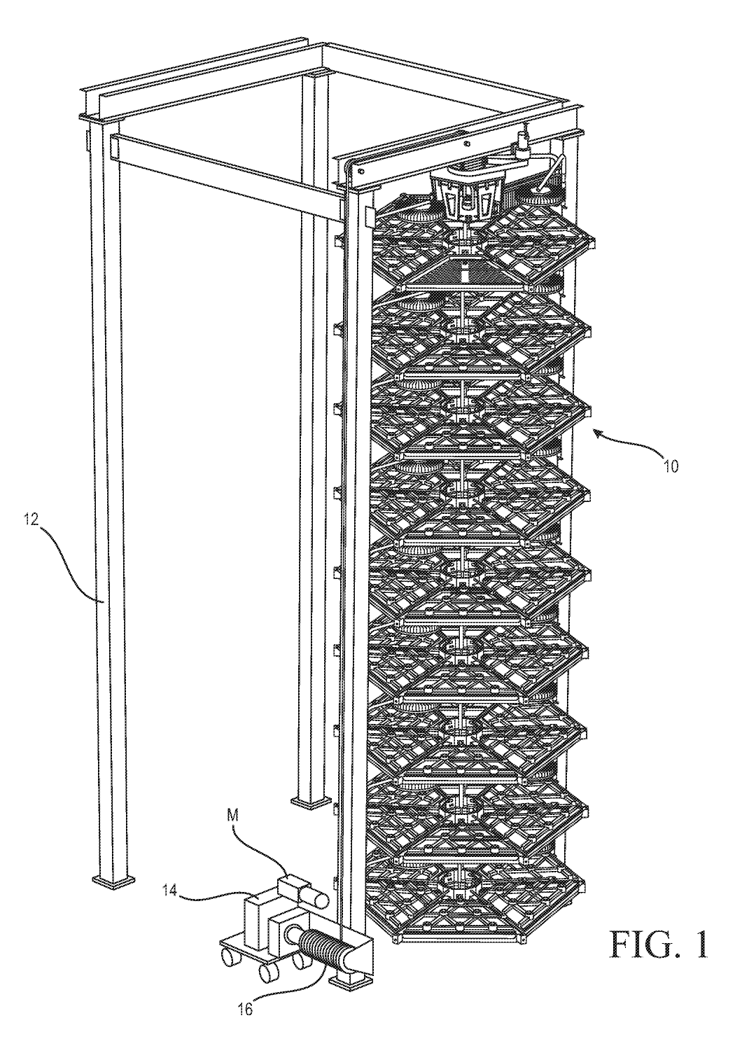

Referring to FIG. 1, vertical frame 12 supports a vertical stack of spaced apart, symmetrical, in this case hexagonal, growing stations 10. The stack can be suspended from the frame 12, as shown, or can rest on a base, in either case for rotation about the vertical axis of the stack of stations 10. In the embodiment shown, motor M and gear box 14 operate cable spool 16 which is used to raise and suspend stations 10 at spaced apart intervals as is disclosed in greater detail herein.

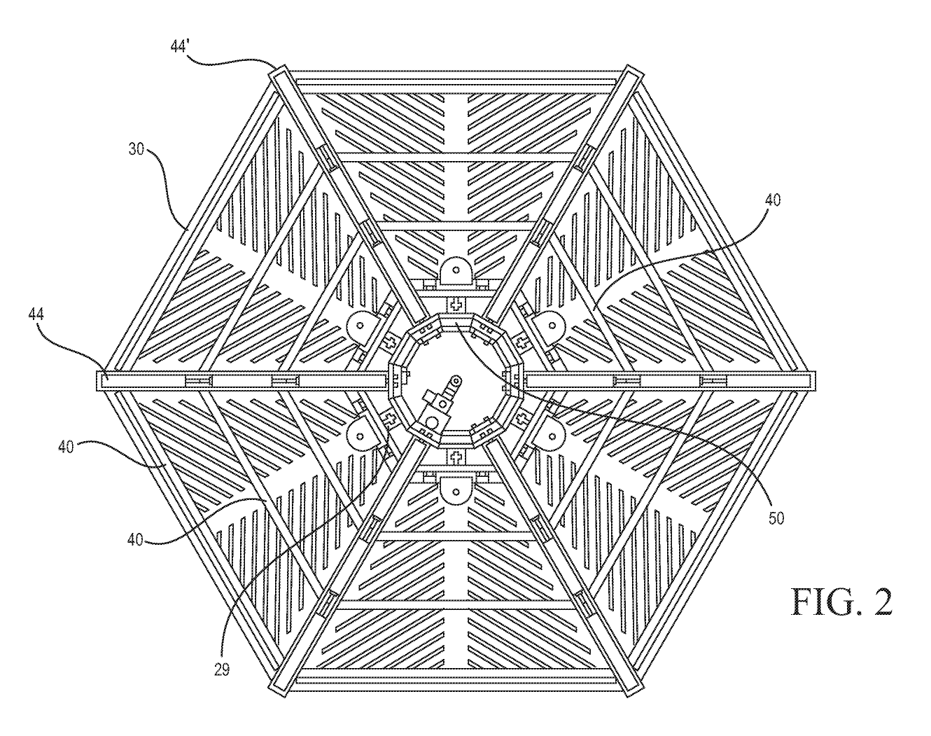

FIG. 2 shows the bottom or underside of a growing station wherein arms 44 radiate from core member 50 to define V-shaped sections with cross members 40 which together form the hexagonal shape of the growing station. Each V-shaped section of arms 44 and members 40 supports trays 30 which in turn support plant trays with the same general shape. The end of each arm 44 has an aperture 44′ which can be used to align stations 10 in a stack as shown in FIG. 1.

Growing stations 10 are not restricted to any shape and can be round or polygonal provided they are symmetrical about a central axis or point to facilitate balanced rotation.

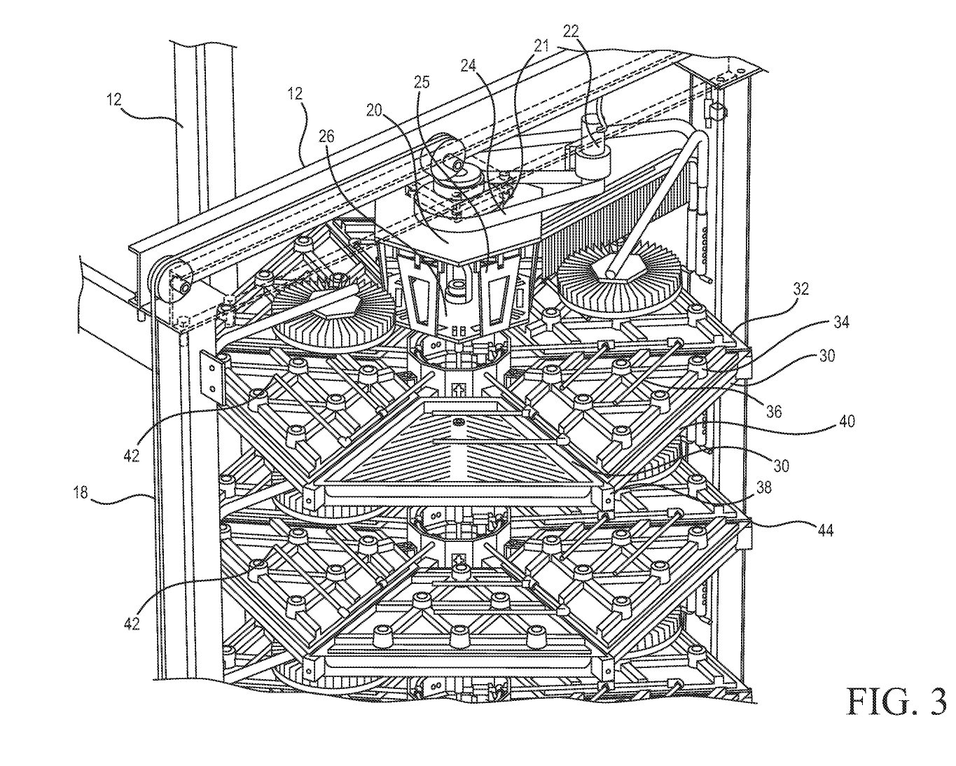

FIG. 3 shows cable 18 (from cable spool 16, FIG. 1) which connects with an upper support assembly made of upper and lower hexagonal plates 20 and 26 connected by brackets 25. Each corner of plate 26 suspends chains 28 which, as shown, engage chain brackets 29 carried by core member 50 (FIG. 2) of each growing station 10. In the embodiment illustrated, chains 28 and brackets 29 are used to suspend each growing station a selected distance from the next below station so as to provide room for plant growth.

Belt 24 is driven by motor 22 to rotate gear 21 on plate 20 to effectively rotate the stack of stations 10 about its vertical axis. A suitable bearing attached to cable 18 allows the entire assembly to turn when motor 22 is engaged. The use of chains 28 and brackets 29 in combination with cable spool 16 facilitates the erection of a stack by attaching a first station at floor or working level followed by lower stations which are attached as the prior stations are raised until the full stack is realized as shown in FIG. 1.

Other means can be used to vertically stack and space the growing stations such as a hollow central core to which arms 44 can be attached at selected intervals. Such a core can rest on a base that can be rotated.

Each support tray 30 receives a plant tray 32 which in the embodiment shown can be provided with a series of plant holding members 32 for receiving, for example, new strawberry plants. Trays 32 can be flat without members 32 to receive potted strawberry or like plants.

Above each growing station 10, three arms 52, adjustably carried by frame 12, suspend growth promoting light sources 54 which preferably are an array of light emitting diodes (LEDs) but can be other known high intensity light sources. Arms 52 allow the light sources 54 to swing out of the way for cropping or repositioning of the growing stations 10.

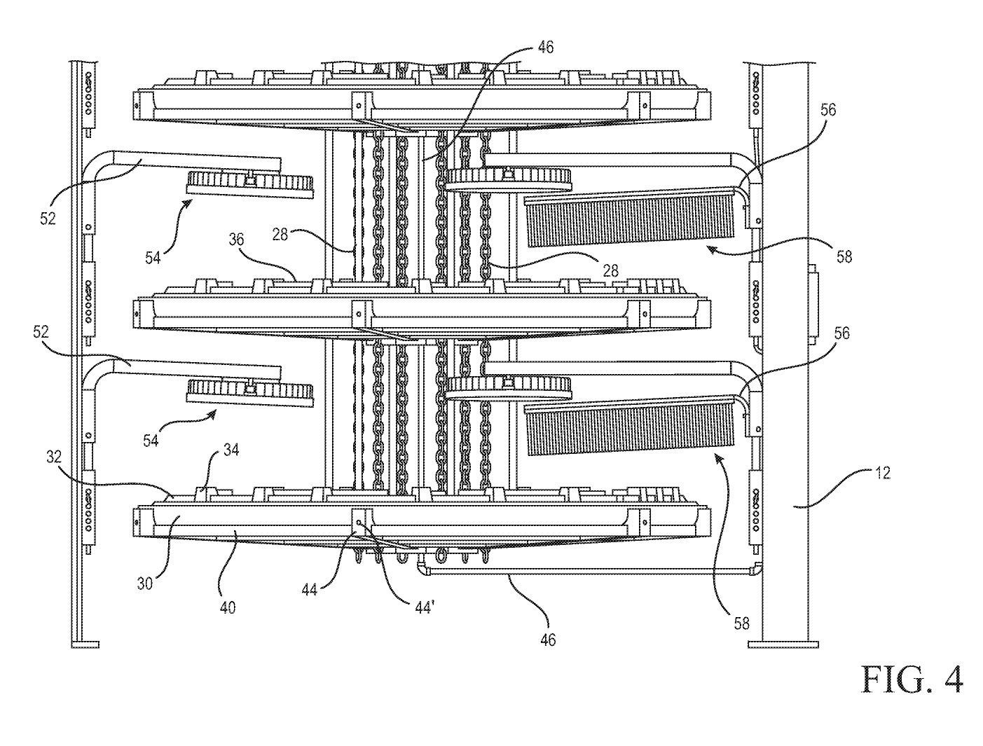

One of the arms 52 at each growing station carries a second arm 56 which suspends a pollinator 58 (FIG. 4) made of microfibers which hang down a suitable distance to contact the plants as they rotate and disturb same so as to effectively cross-pollinate the plants. The use of bees is thus done away with and allows the invention to be carried out in a controlled atmosphere where humidity, temperature and air quality can be regulated for optimum plant growth.

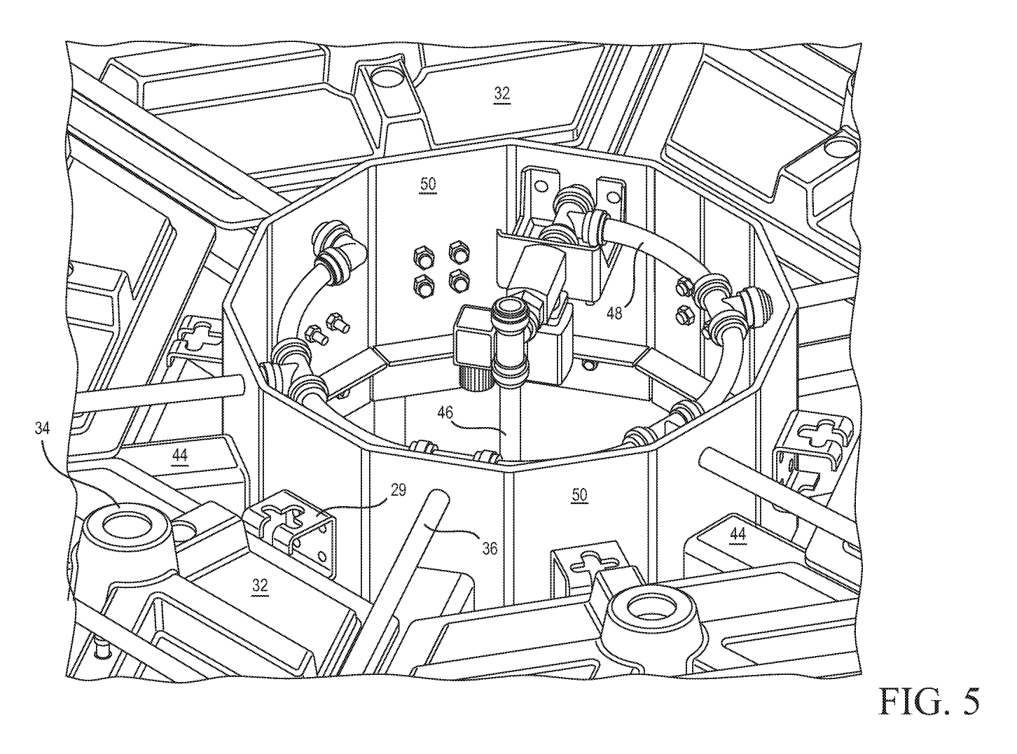

Plants can be watered and supplied with known plant nutrients by misting and/or flooding plant trays 32. In a preferred embodiment for growing strawberries, misters 38 positioned above the growing plants (FIG. 3) are fed via pipes 36 which in turn receive water from standpipe 46 and manifold 48 located inside each core support member 50 (FIG. 5). Known drainage and water recovery systems can be used with the invention.

While the invention is especially suited to growing strawberries, other fruits like blueberries, blackberries, raspberries and the like can be grown as well as herbs and green leafy plants and the like.

While this invention has been described as having preferred sequences, ranges, ratios, steps, order of steps, materials, structures, symbols, indicia, graphics, color scheme(s), shapes, configurations, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the claims appended hereto or presented later. The invention, therefore, is not limited to the preferred embodiment(s) shown/described herein.

What is claimed is:

1. Method for growing plants comprising:
(a) providing a vertical stack of spaced, symmetrical growing stations each having a plant tray;
(b) placing plants to be grown on said plant trays;
(c) rotating said stack causing said plants to be contacted by a pollinator which cross-pollinates the plants;
(d) exposing said plants to growth promoting light sources during periods of plant growth;
(e) watering said plants at selected intervals; and
(f) cropping said plants when mature.

2. Apparatus for growing plants comprising:
(a) a vertical stack of spaced apart symmetrical growing stations each supporting a plant tray adapted to receive plants to be grown;
(b) means to rotate the vertical stack about its vertical axis;
(c) means to cross-pollinate said plants as they rotate on their respective trays;
(d) growth promoting light sources positioned above each growing station adapted to operate during periods of plant growth; and
(e) means to deliver water to said plants at selected intervals.
